(19) United States
(12) Patent Application Publication
(10) Pub. No.: US 2010/0164140 A1
(43) Pub. Date: Jul. 1, 2010

(54) BATTERY FORMWORK FOR THE VERTICAL MANUFACTURING OF PLANAR PRECAST CONCRETE PARTS

(76) Inventor: Andreas Reymann, Hockenheim (DE)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(21) Appl. No.: 12/597,353

(22) PCT Filed: Apr. 14, 2008
(86) PCT No.: PCT/EP2008/054484

§ 371 Date: Mar. 9, 2010

(30) Foreign Application Priority Data
Apr. 23, 2007 (DE) 10 2007 019 383.3

(51) Int. Cl. B29C 39/04; E04G 11/08

(52) U.S. Cl. 264/299; 249/27

(57) ABSTRACT

A battery formwork for the vertical manufacturing of planar precast concrete parts comprising two outer formworks, which are located diametrically opposite and at least one of which is movable, and an inner formwork, which is located between the outer formworks. The inner formwork has at least two side supports, which laterally delimit the concrete part to be manufactured. A floor support of the inner formwork is fixed in its location and delimits the concrete part to be manufactured on the bottom. The floor support is used as the lower reference point for the manufacturing of the precast concrete part. The battery formwork has a horizontally extending height support, which is vertically changeable in its position and which delimits the precast concrete part to be manufactured on top.

### TECHNICAL FIELD OF THE INVENTION

The present invention relates to a battery formwork for the vertical manufacturing of planar precast concrete parts comprising two outer formworks, which are located diametrically opposite, and at least one of which is movable, and an inner formwork, which is located between the outer formworks.

### BACKGROUND

In order to produce precast concrete parts, in particular concrete walls, in the installed location, using so-called battery formworks is known. Battery formworks allow space-saving manufacturing of concrete walls. In addition, it is one of the few possibilities for producing precast concrete parts whose two diametrically opposite surfaces have fair-faced concrete quality.

In the known battery formworks, an inner formwork having two formwork areas, which are separated by a formwork panel, is located in a predetermined outer formwork having a height which corresponds to the maximum height of the precast concrete parts to be manufactured. The outer formworks may typically each be pivoted about an axis in such a manner that the inner formwork having the finished produced concrete finished parts can be removed.

Battery formworks of this type have the disadvantage that the precast concrete part to be manufactured is constructed from the upper edge of the battery formwork. Liquid concrete is poured from above into the battery formwork between the inner formwork and the outer formwork. If self-compacting concrete (SCC) is used, it is poured in slowly and compacts by itself. Normal concrete is poured in layer by layer and compacted. The last layer, which reaches up to the upper edge of the battery formwork, is drawn off using a mechanical squeegee, so that an upper front face results.

If precast concrete parts are produced, whose height does not correspond to the height of the battery formwork, the height of the concrete part to be manufactured must be measured from the upper edge of the outer formwork and a variable floor support must be mounted at the corresponding position. For this purpose, framework constructions must be introduced between the inner formwork and the outer formwork, so that the floor support is brought to the appropriate position and is fixed there. Alternatively, the floor support can be fastened on the outer or inner formwork using a magnet. The concrete is again poured in up to the top to fill the formwork, which is thus made smaller. In a battery formwork having a height of 3 m or 4 m and during the production of a precast concrete part having a height of 1 m, for example, work must be performed at the maximum height of the battery formwork, as previously. A framework is externally mounted on the battery formwork, on which assembly workers monitor the filling of the concrete and/or manually produce the surface of the upper front face. The construction of floor supports of different heights and the construction of frameworks outside the battery formwork are complex. The work at the corresponding height of 3 m or 4 m results in significant danger.

### SUMMARY

An object of the preferred embodiment of the present invention is to propose a battery formwork, using which planar precast concrete parts, whose height does not correspond to the height of the battery formwork, may also be produced easily.

The present object is achieved by the battery formwork having the features of claim 1. The object is also achieved by a method having the features according to claim 12. The related subclaims relate to advantageous, non-obvious embodiments of the invention.

The battery formwork according to a preferred embodiment of the invention for the vertical manufacturing of planar precast concrete parts comprises two outer formworks, which are located diametrically opposite, and at least one of which is movable. Both outer formworks are preferably movable, so that the intermediate space between them can be made smaller and larger. An inner framework which is part of the battery framework can be located between the outer formworks. In particular, it is pushed between the outer formworks. The inner framework has at least two side supports, which represent the dimensions of the precast concrete part to be manufactured. They thus delimit the finished concrete part on the sides. The inner framework has at least one floor support, which is fixed in its location, in particular in its vertical location. The floor support delimits the concrete part to be manufactured on the bottom. It is used as the lower vertical reference point during the production of a precast concrete part. The battery formwork additionally has a horizontally extending height support. The height support can be vertically changed in its position and its distance from the floor support determines the height of the precast concrete part to be manufactured.

The battery formwork according to a preferred embodiment of the invention has the advantage that the floor support is fixed in its position. It is used as the reference point for the manufacturing. Only the height support is adjusted in its height. The precast concrete part is thus always constructed from the bottom. Working on the upper edge of the outer formwork, as is necessary in formworks of the prior art, is avoided. Thus, work is performed in proximity to the floor during the production of precast concrete parts of lesser height. It is not necessary to attach frameworks to the battery formwork, in order to also work on the upper reference point, i.e., on the upper edge of the battery formwork, for precast concrete parts of low height.

For this purpose, at least one inlet for the concrete supply is preferably provided in the outer formwork above the floor support of the inner formwork, i.e., in the floor area. Flowable concrete can be introduced through the inlet into the battery formwork. The concrete is preferably pumped into the battery formwork. A method of this type is described in detail in EP 06 023 710. The content of the EP application is made part of the content of the present application by reference.

At least one inlet is preferably provided on each of the outer formworks. Multiple inlets are particularly preferably located distributed along the outer formwork. It is also possible to locate multiple inlets at different heights. However, this is typically not necessary. If multiple inlets are located adjacent to one another, multiple different parts may also be produced inside the battery formwork, in particular if a side support is provided in the battery formwork between the inlets and if the height support is replaced by multiple divided short height supports. Only the thickness of the individual parts must always remain the same.

In a special embodiment, the height support is positioned on the outer formwork. This has the advantage that it can be fixed and moved using a simple construction. The height support is preferably moved mechanically. In addition to an automatic movement, a semiautomatic movement is also conceivable. For example, the height to which the height support is to move can be set beforehand. An intervention or an adjustment by hand by the operator during the production procedure of a precast concrete element is then not necessary. The procedure and/or the setting of the height support can be performed program-controlled and automatically.

The machine setting of the height support can be motorized by a gearbox or by spindles driven by means of servomotors or by similar means. A hydraulic adjustment of the height support into the desired position is particularly preferred.

In addition to the mechanical, preferably automated setting of the height support, in another preferred embodiment the position of the height support can also be changed manually. The height support is particularly preferably moved by hand and fixed in its position using magnets. For this purpose, it is necessary for the outer formwork to comprise steel, which is typically provided. Alternatively, the height support can be located on the inner framework, because it is also made of metal.

In a preferred embodiment, the outer formworks are translationally movable. At least one of the outer formworks is moved at a time. Preferably, both outer formworks are moved parallel to one another. It is thus possible to produce arbitrarily wide precast concrete elements, because a distance which is equal over the height is always provided between the outer formwork and the inner formwork. The translational movement is particularly preferably caused using a hydraulic drive. Multiple hydraulic arms may be used in order to ensure an exact and parallel displacement of the outer formwork. The number of the hydraulic arms used depends on the dimensions of the outer formwork, in particular the length thereof.

Using a battery formwork of this type, in which the outer formwork is translationally moved, a floor formwork can also be located between the two outer formworks instead of the inner formwork and a displacement body or shrinking core can be positioned above the floor formwork. In this manner, one-piece spatial modules having two walls and a floor part, which have a monolithic structure, can also be produced using the battery formwork according to the invention.

In a preferred embodiment, the outer formwork has a formwork panel, which is reinforced by horizontal and vertical reinforcement ribs. The formwork panel can be relatively thin and nonetheless apply the appropriate forces which are necessary to withstand the delivery pressure as concrete is pumped into the battery formwork. In a preferred embodiment, the formwork panel is flexible perpendicularly to its surface normal, however. The formwork panel is thus deflectable by a few millimeters or centimeters in the direction of the surface normal over its entire extension. This has advantages in particular during the stripping. The finished concrete part will detach from the flexible outer formwork during the striking and remain on the inner formwork due to the occurring adhesion forces. The precast concrete parts may be fixed and/or clamped on the inner formwork, in order to be kept in their position for the further transport within the production process and/or for further processing.

The two outer formworks are particularly preferably clamped to one another during the manufacturing of the precast concrete part in such a manner that the otherwise flexible formwork panel of the outer formwork is rigid perpendicular to the surface normal in the clamped state. This is necessary so that precast concrete parts may be produced in a uniform thickness. The clamping of the two outer formworks to one another can be caused by hydraulic props, for example, which draw the two outer formworks toward one another.

During the vertical manufacturing of planar precast concrete elements, according to the invention, a battery formwork is used which comprises two opposing outer formworks and one inner formwork. The inner formwork has a fixed floor support and at least two side supports. The side supports, which represent side formwork parts, are located at the desired lateral position on the inner formwork. The position of the individual side supports and/or their distance relative to one another depends on the concrete part to be produced. The side supports are located in such a manner that they terminate flush with the floor support, and in particular are located perpendicularly to the floor support, in order to produce right-angled precast concrete parts. However, another configuration of the side supports is also conceivable.

The inner framework prepared in this manner having the positioned side supports is located between the two outer formworks. The outer formworks are spaced apart from the inner formwork. In the next step, a vertically extending height support is positioned in the desired vertical position relative to the floor support of the inner formwork. The vertical distance between the floor support of the inner formwork and the height support corresponds to the height of the concrete part to be manufactured. The height support is preferably positioned on the outer formwork and can be moved into the desired position here.

In the next step, the outer formworks are moved toward the inner formwork in such a manner that they touch the inner formwork on the side supports. The depth of the side supports corresponds to the depth of the height support. A closed cavity thus results, which is delimited by the inner formwork, the outer formwork, the floor support, the two side supports, and the height support. The cavity has the dimensions and shape of the precast concrete part to be produced.

The outer formworks are now fixed in their position. For this purpose, they are preferably clamped against one another in such a manner that they are rigid. The outer formworks themselves thus no longer yield, so that precast concrete parts which have the desired contour may be produced.

In a further step, a filling system is connected to inlets of the outer formwork. The inlets are located in the floor area of the outer formwork in such a manner that they are located above the floor support of the inner formwork. The configuration and size of the inlets are a function of the contour of the precast concrete part to be produced. Typically, a single inlet per precast concrete part to be produced is sufficient. A filling attachment is preferably located on the inlet, as is described in greater detail in DE 10 2006 053 552, for example.

The battery formwork is now filled from below until it is completely filled. The filling is preferably implemented by pressure filling. A procedure of this type is described in EP 06 023 710. In a preferred design of the method according to the invention, side supports which have guide openings are used. The outer formwork has guide pins corresponding to the guide openings, which project into the guide openings when the outer formwork is pushed together with the inner formwork. The position of the side supports is thus fixed once again, on the one hand. The side supports are additionally stabilized, in particular against the lateral pressure exerted by the concrete which is filled in, on the other hand.

In a further design of the method, after the filling of the battery framework and the curing of the concrete, fixing units for clamping the two outer formworks are detached. The outer formwork, in particular the formwork panel thereof, becomes flexible. The outer formwork can move by a few millimeters in the direction of its surface normal. In the next step, the outer formwork is detached from the precast concrete element. The detachment from the precast concrete part is supported by the flexible behavior of the outer formwork. It is thus ensured that the precast concrete part only detaches from the outer formwork, but not from the inner formwork. The outer formworks are subsequently moved outward, so that the outer formwork is removed completely from the precast concrete part. Alternatively and/or additionally, the height support can already be moved upward before the outer formwork is moved further away. It is thus ensured that the upper front face of the precast concrete part is not damaged during the detachment. The detachment procedure is simplified.

In a further step, the inner formwork between the two outer formworks is moved outward. The precast concrete part is positioned on the inner formwork. The precast concrete part is partially fastened on the inner formwork, for example, by clamps, which function according to the principle of an F-clamp. The precast concrete part can now be moved on the inner framework within the assembly hall, without a danger that the precast concrete part will fall off from the inner framework and tip over.

In a further step, the precast concrete part is then stripped and/or post-processed in a further processing step.

The invention is explained in greater detail hereafter on the basis of a preferred embodiment illustrated in the figures. The special features shown therein may be used individually or in combination to provide preferred embodiments of the invention. The described embodiment does not represent a restriction of the generality of the subject matter defined in the claims.

### BRIEF DESCRIPTION OF THE DRAWINGS

FIG. 1 shows a perspective illustration of a battery formwork.

FIG. 2 shows a side view of the battery formwork from FIG. 1.

### DETAILED DESCRIPTION OF EXEMPLARY EMBODIMENTS

In the following description, like numbers refer to like elements.

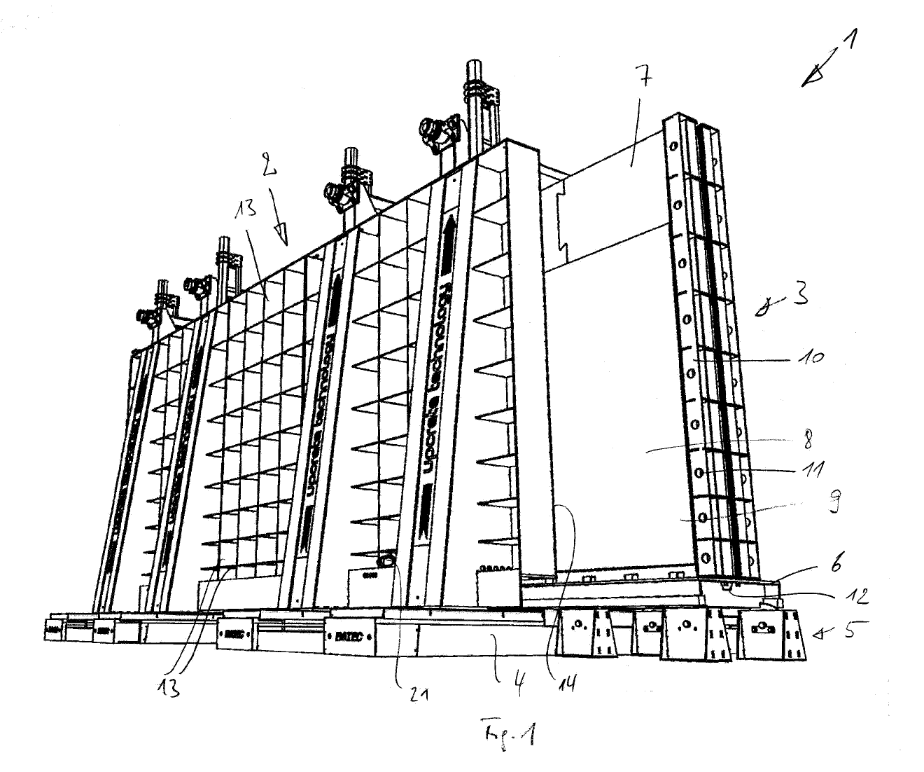

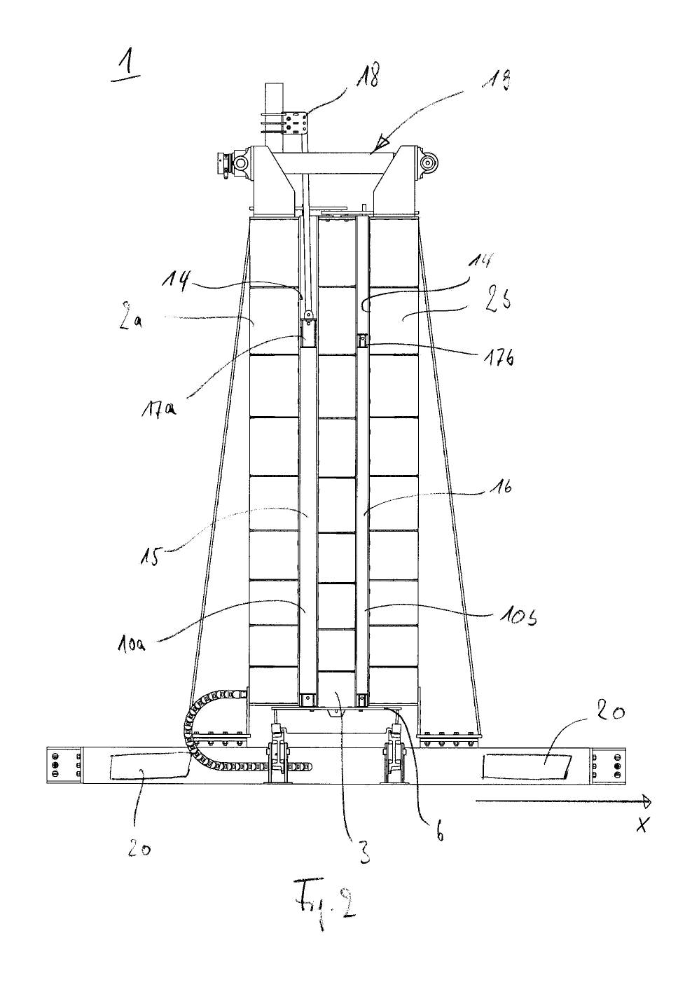

FIG. 1 shows a perspective view of a battery formwork 1 according to the invention, which comprises two outer formworks 2 and one inner formwork 3. The second outer formwork 2 is not shown in FIG. 1 because of the perspective; however, both outer formworks 2 are clearly recognizable in FIG. 2.

The outer formwork 2 is mounted on a substructure, which is implemented as a pedestal 4, and can be moved translationally in one spatial direction. The inner formwork 3 is moved perpendicularly to the outer formwork 2 and is mounted on a roller system 5. It can thus be pushed easily between the two outer formworks.

The inner formwork 3 comprises a floor support 6, which is oriented horizontally. An inner panel 7 extends in the vertical direction and forms a right angle with the floor support 6. The inner formwork 3 is constructed mirror-symmetrically, the inner panel 7 forming the mirror axis. A precast concrete part can be positioned and produced on each of the two sides of the inner panel 7. The two top sides of the inner panel 7 thus form the formwork delimitation for the precast concrete part.

A side support 10, which extends vertically, is located in the outer area 9 on the front side 8 of the inner panel shown here. The side support 10 comprises guide openings 11, which are located at equidistantly. However, they may also be positioned at different distances from one another. Guide pins (not shown) extend into the guide openings 11, so that when the battery formwork 1 is assembled, the guide pins of the outer formwork 2 engage in the guide openings 11 and thus stabilize the side support 10.

The side support 10 is mounted so it is rotatable around a rotational axis 12, which also extends vertically. Particularly simple opening of the side support 10 is thus made possible, so that the stripping of the produced precast concrete part is simplified.

The outer formwork 2 has reinforcement ribs 13 on its outer side, which extend horizontally and vertically. The outer formwork 2 has a formwork panel 14, which is oriented toward the inner formwork 3. The reinforcement ribs 13 are fastened on the formwork panel 14. The formwork panel 14 itself is flexible (pliable), i.e., it can be deformed in the direction toward the inner formwork by a few millimeters over its entire length.

It may be seen clearly from FIG. 2 that the floor support 6 of the inner formwork 3 is fixed in its height. It may not be changed. The floor support 6 thus represents the reference point for the construction and for determining the height of a precast concrete part to be manufactured. Each precast concrete part to be manufactured is oriented to the floor support 6.

FIG. 2 shows a special feature having an inner formwork 3 which is not completely symmetrical. The left formwork chamber 15 has a greater width than the right formwork chamber 16. This is implemented by the two side supports 10a, 10b, which have different widths. Correspondingly, the two height supports 17a, 17b must also have different widths. Their width is adapted to the width of the side supports 10a, 10b. Two precast concrete parts of different widths may thus be produced in one manufacturing procedure. This makes the manufacturing method particularly cost-effective. The position of the inner formwork 3 in the X direction is fixed by the roller system 5. Correspondingly, the two outer formworks 2a, 2b must be moved differently as a function of the side supports 10a, 10b. Because the two outer formworks 2a, 2b may be moved independently of one another, this is not a problem.

It may be seen clearly from FIG. 2 that the height support 17a is a machine-driven height support. It is moved by a horizontal positioning unit 18 and fixed in its desired position. The position of the height support 17a in the vertical direction may also be set automatically, in that the position can be stored in a control program. The vertical position of the height support 17a is calculated from the reference point, i.e., from the floor support 6.

The height supports 17a, 17b are each located on the outer formwork 2, so that they are moved with the outer formworks 2a, 2b. The height support 17b on the right outer formwork 2b is a height support to be adjusted manually. It is fixed by hand on the formwork panel 14 of the outer formwork 2b by a magnet.

The battery formwork 1 is shown in the telescoped state in FIG. 2. In order to stiffen the flexible formwork panel 14 of the outer formworks 2a, 2b, the two outer formworks 2a, 2b are clamped to one another by a clamping device 19. The clamping device 19 is hydraulically driven and comprises a hydraulic prop. The formworks are fixed to the pedestal 4 during the concrete casting procedure in the lower area of the outer formwork 2 in such a manner that they are kept in their position by a moving apparatus 20, which is preferably also hydraulically driven, and which is only schematically indicated here.

After the two outer formworks 2 have been pushed in parallel into their manufacturing position, as shown in FIG. 2, the formwork chambers 15, 16 may be filled through an inlet 21 in each outer formwork 2a, 2b. The inlet 21 is located in the lower area of the formwork chambers 15, 16 in each case. The flowable concrete is then filled in through the inlet, on which a filling attachment is preferably fastened. Such an inlet 21 is schematically indicated in the outer formwork 2a in FIG. 1.

The foregoing description is of an exemplary and preferred embodiments employing teachings of the invention. The invention, as defined by the appended claims, is not limited to the described embodiments. Alterations and modifications to the disclosed embodiments may be made without departing from the invention. The meaning of the terms used in this specification are, unless expressly stated otherwise, intended to have ordinary and customary meaning and are not intended to be limited to the details of the illustrated structures or the disclosed embodiments.

What is claimed is:

1. Battery formwork for the vertical manufacturing of planar precast concrete parts, comprising
two outer formworks which are located diametrically opposite and at least one of which is movable,
an inner formwork, which is located between the outer formworks and has at least two side supports, which laterally delimit the concrete part to be manufactured,
the inner formwork has a floor support, which is fixed in its location and delimits the precast concrete part to be manufactured on the bottom, the floor support being used as a lower vertical reference point for the manufacturing of the concrete part, and
the battery formwork has a horizontally extending height support, which is vertically changeable in its position and which delimits the precast concrete part to be manufactured on top.

2. Battery formwork according to claim 1, wherein the height support is located on the outer formwork.

3. Battery formwork according to claim 1, wherein the height support is mechanically movable, and is preferably movable automatically or semiautomatically.

4. Battery formwork according to claim 3, wherein the height support is hydraulically movable.

5. Battery formwork according to claim 1, wherein the height support is manually changeable in its position.

6. Battery formwork according to claim 5, wherein the height support is fixed in its position by means of magnets.

7. Battery formwork according to claim 1, wherein the outer formwork is moved translationally, wherein the translational movement is preferably caused by means of a hydraulic drive.

8. Battery formwork according to claim 1, wherein the outer formwork, in a floor area or above the floor support of the inner formwork, comprises at least one inlet for the concrete supply, flowable concrete is supplied into the battery formwork through the at least one inlet.

9. Battery formwork according to claim 8, wherein multiple inlets are located distributed along the outer formwork.

10. Battery formwork according to claim 1, wherein the outer formwork includes a formwork panel, which is reinforced by a horizontal and vertical reinforcement ribs and is flexible perpendicular to the surface normal.

11. Battery formwork according to claim 10, wherein the two outer formworks are clamped to one another during the manufacturing of the precast concrete part in such a manner that the formwork panel of the outer formwork is rigid perpendicular to the surface normal.

12. Method for the vertical manufacturing of planar precast concrete parts using a battery formwork comprising:
providing a battery formwork having two outer formworks located diametrically opposite and an inner formwork having a floor support and at least two side supports;
positioning the side supports on the inner formwork;
positioning the inner formwork between the outer formworks;
positioning a height support in the desired vertical position relative to the floor support of the inner formwork in such a manner that the vertical distance between the floor support and the height support corresponds to the height of the precast concrete part to be manufactured;
moving the outer formworks toward the inner formwork until they contact the inner formwork;
fixing the outer formworks in their position, in such a manner that the outer formworks are rigid;
attaching a filling system to inlets of the outer formworks, which are located in a floor area or above the floor support of the inner formwork; and
filling the battery formwork from below, preferably by pressure filling, until the battery formwork is completely filled.

13. Method according to claim 12, further comprising:
detaching the fixing of the outer formwork, whereby the outer formwork becomes flexible;
detaching the outer formwork from the precast concrete part;
moving the outer formwork outwardly;
removing the inner formwork having the precast concrete part; and
stripping and/or further processing of the precast concrete part.
